(19) United States
(12) Patent Application Publication
(10) Pub. No.: US 2002/0064055 A1
(43) Pub. Date: May 30, 2002

(54) Computer with illuminator for keyboard

(76) Inventors: Tomoyuki Takahashi, Fujisawa-shi (JP); Kazuhiko Yamazaki, Hiratsuka-shi (JP); Shigeru Yoshida, Yamato-shi (JP); Yukifumi Nakazawa, Tokyo-to (JP); Nobuyuki Kawashima, Tokyo-to (JP)

Correspondence Address: IBM CORPORATION, PO BOX 12195, DEPT 9CCA, BLDG 002, RESEARCH TRIANGLE PARK, NC, 27709, US

(21) Appl. No.: 09/726,207

(22) Filed: Nov. 29, 2000

(51) Int. Cl. F21V 33/00

(52) U.S. Cl. 362/555; 362/253

(57) ABSTRACT

In a portable computer 100, an LED holder 150 is provided in the upper portion of an LCD 109 and an LED is attached inside the LED holder 150. Light emitted from the LED passes through an aperture provided in the bottom portion of the LED holder 150 and illuminates a keyboard 103.

### FIELD OF THE INVENTION

The present invention relates to battery-driven computers with a light source for illuminating a keyboard thereof.

### DESCRIPTION OF THE RELATED ART

Portable computers are excellent in portability because they are small in size and light in weight, and can be used at any place independently of commercial power sources by mounting a battery charger in the interior. Generally, the portable computers are provided with a liquid crystal display (LCD), and many contrivances have been made in order to economize the consumption power of the battery. Since computers have generally been used in recent years at places remote from offices, there is an increasingly strong demand for using computers under a dark environment, for example, in an airplane or a living room. To use computers, there is a need for users to operate the keyboard and the pointing device while viewing the LCD. Because most LCDs are provided with a back light at the back side thereof, users can view the screen even if the surroundings are dark. However, since the keyboard and pointing device do not emit light unless they employ fluorescent paint or material, users cannot visually recognize a key position or a script on the key top in the dark and therefore users, other than an experienced person who can handle computers without relaying on vision, cannot sufficiently use computers under such an environment. In addition, the back light of the LCD does not provide illumination enough to operate the keyboard.

Published Unexamined Utility Model Application No. 59-4493 (Japan) (creator of device, Suganuma and Yajima) discloses a technique of providing an illuminator in electronic equipment such as an electronic register and illuminating a keyboard thereof, as shown in FIG. 1. The illuminator is provided in the upper end of the front surface of the register, and when the register is used, the keyboard can be illuminated. This electronic register, however, is not a portable type but an installed type and is based on the assumption that commercial power sources can be utilized. In addition, the light source shown in FIG. 1 is considered to be an incandescent electric light.

Published Unexamined Patent Application No. 8-314598 (Japan) (inventor, Sugawara) discloses a technique of illuminating the keyboard of a personal computer (PC), as shown in FIG. 2. The light source is disposed between the keyboard and the display section and attached on the main body of the PC. In addition, the light source is partially covered so that light is not emitted to a place other than the keyboard. Furthermore, in the aforementioned specification No. 8-314598 it has been described that “In addition, when the light source is attached to the liquid crystal section, it becomes possible to visually recognize the keyboard in the dark place, but there is a problem that (1) a large-capacity light source is required, because the liquid crystal section and the keyboard are illuminated and (2) in the case of a liquid crystal section with a back light, light enters the liquid crystal and therefore disturbs the field of vision. Therefore, the aforementioned specification No. 8-314598 has taught that attaching the light source to the liquid crystal section has been given up because there is a problem from the viewpoint of both the capacity of the light source and the visual field with respect to the liquid crystal section.

Published Unexamined Utility Model Application No. 7-25415 (Japan) (creator of device, Shinomura and Sasaki) discloses a technique of providing a detachable light source in a notebook-sized PC and illuminating the keyboard. In this publication, the light source is not attached to the main body of the PC and is provided as a separate unit.

### PROBLEMS TO BE SOLVED BY THE INVENTION

As described supra, the portable computer is characterized in that it is excellent in portability. Therefore, in the case of providing a light source for illuminating the keyboard, it is important to select a method of attachment and an illuminator type so that the portability is not degraded. It is also important that an illuminator does not very shorten the operating time of a battery.

The above-mentioned conventional techniques have shown the necessity of illuminating the keyboard of the portable computer. However, as described infra, it is difficult to adopt these techniques, while the characteristic of an actual portable computer is being utilized. Published Unexamined Utility Model Application No. 7-25415 (Japan) does not adopt the method of attaching an illuminator to the main body of the computer and adopts the detachable method. In this method, however, there is a need to carry the light source separately from the computer. Thus, this method cannot utilize the characteristic of the PC that is characterized by portability and also the operation of detachably attaching the light source will give users trouble.

In the aforementioned Published Unexamined Patent Application No. 8-314598 (Japan), the light source is disposed between the keyboard and the LCD. Disposing the light source at this position, however, will cause some problems. First, in portable computers, a large area is used on this side of the keyboard in order to ensure the palm rest portion that holds the palms of a user when the user operates the keyboard. For this reason, in many cases it is difficult to ensure space for the light source at the position shown in FIG. 2. In addition, there is a need to make the light source higher than the plane of the key top of the keyboard and provide a cover, in order to illuminate the entire keyboard from the position of the light source shown in FIG. 2. For this reason, if an 30 attempt is made to close the cover including the LCD, the computer will become considerably thick. Furthermore, because the entire keyboard is illuminated with the light source disposed at the position shown in FIG. 2, there is a need to provide a plurality of point light sources or an elongated light source and therefore a problem with the consumption power of the battery will arise.

The aforementioned Published Unexamined Utility Model Application No. 59-4493 (Japan) discloses that the light source is disposed on the upper portion of the display section, but it does not disclose a specific idea for disposing the light source at the same position in a portable computer. Although this conventional technique discloses an idea for illuminating the keyboard with the light source disposed on the upper portion of the display section, there is no description of a specific method for disposing the light source on the upper portion of the LCD of a portable computer.

After all, the technique of illuminating the keyboard of a portable computer with a light source disposed on the upper portion of the LCD has hitherto been difficult and has not been realized. But, when the LCD is open in order to use the portable computer, there is no obstacle to intercept light between the upper portion of the LCD and the keyboard and therefore it follows that the upper portion of the LCD is most efficient as a position of illuminating the keyboard. However, since a distance from the light source to the keyboard becomes longer, it becomes important that an illuminator as a light source have a great luminous intensity and a lower energy consumption amount. Furthermore, when the keyboard is illuminated from the upper portion of the LCD, there is a need to elaborate a plan so that the visual recognition of the LCD is not disturbed by direct light incident on the LCD. The present invention solves these problems and realizes illumination for the keyboard of a portable computer not obtained in the background art.

Accordingly, the primary object of the present invention is to provide a batter drivable computer which disposes a light emitting diode (LED) on the upper portion of a display such as a liquid crystal display (LCD) and realizes an excellent illumination of keyboard. More specifically, the object of the present invention is to provide a computer that can be utilized even by a battery driven operation with low consumption power and without occupying a lot of space and does not have an adverse effect on the visual recognition of the display.

### SUMMARY OF THE INVENTION

In accordance with a first aspect of the present invention, there is provided a computer capable of battery powered operation, having a keyboard and a display comprising: an LED holder installed at approximately an upper edge of the display, the holder having a wall formed with an aperture; and an LED installed inside the wall of the LED holder, wherein light radiated from the LED illuminates the keyboard by passing through the aperture.

First, in the present invention, a light emitting diode (LED) is selected as a light source for keyboard illumination. Generally, the LED has been used in displaying the operating state of electronic equipment and has been used as a device for displaying states rather than as a device for illumination. However, since LEDs with a relatively high luminous intensity suitable for illumination have been developed in recent years, the inventor of this application is led to an idea of applying the LED to the illumination of the keyboard of a portable computer to solve the problems not solved in the background art. The LED is suitable as an illuminator for a keyboard to be mounted on a battery drivable computer, because it is small, low in consumption power, and does not almost shorten the operating time of a battery.

In addition, an LED holder is attached to substantially the upper edge of a display and an LED is held within the LED holder. This position is most suitable as a place for attaching a light source because there is no obstacle with respect to keyboard illumination. In addition, by disposing a light source here, only a single point light source can illuminate the entire keyboard and there is no need to prepare a plurality of point light sources, a line light source, or a surface light source. The wall of the LED holder is formed with an aperture, and light from this LED is passed through the aperture and guided to the keyboard. The distribution of the light passed through the aperture can be controlled by adjusting the position at which the LED holder is attached and also the size and position of the aperture in the wall of the LED holder.

In accordance with a second aspect of the present invention, a part of the light radiated from the LED is masked by the wall of the LED holder, and the remaining light passing through the aperture does not directly illuminate the display. This is realizable by suitably selecting, for example, the configuration of the holder, the attached position of the holder, the position of the aperture, the size of the aperture, and the like. Therefore, the second form of the present invention has solved the problem that when a light source is provided in the upper portion of the display, light radiated from the light source will disturb the visual recognition of the display, such as the problem pointed out in the background art.

In accordance with a third aspect of the present invention, when the display is opened so that it is held at approximately 90 degrees to the main body, light from the LED passes through the aperture so that it illuminates substantially the keyboard alone. The angle of approximately 90 degrees is considered to be the smallest angle when a user uses the computer. If the entire keyboard is illuminated at this angle, the illumination of the keyboard will be sufficiently ensured even if the back cover is further opened. As with the second embodiment, this is also realizable by suitably selecting, for example, a parameter related to the aperture.

In accordance with a fourth aspect of the present invention, the LED holder is provided with a shutter that adjusts the opening degree of the aperture. Therefore, the user can adjust light distribution in accordance with the inclined state of the display by manually adjusts the position of the shutter.

In accordance with a fifth aspect of the present invention, an LCD is selected as a display and a portable computer is selected as a computer. The present invention is particularly effective in portable computers, because there are many cases where keyboard illustration is required, as compared with an installed type.

In accordance with a sixth aspect of the present invention, the LED is switched off when the back cover is closed. In this way, the battery is prevented from being consumed by closing the back cover without switching off the LED.

### BRIEF DESCRIPTION OF THE DRAWINGS

FIG. 1 is a schematic diagram showing a conventional register with an illuminator for the keyboard;

FIG. 2 is a schematic diagram showing a conventional personal computer with a light source for the keyboard;

FIG. 3 is a perspective view showing an embodiment of a portable computer according to the present invention;

FIG. 4 is an exploded view showing the disassembled state of the back cover, the LCD, and the LED holder shown in FIG. 3;

FIG. 5 is a detailed diagram showing an embodiment of the LED holder shown in FIG. 4;

FIG. 6 is a sectional view showing how the LED holder is attached;

FIG. 7 is a diagram for describing the light distribution characteristic of the light emitted from an LED held by the LED holder;

FIG. 8 is a diagram for describing the light distribution characteristic;

FIG. 9 is a sectional view of an LED holder with a shutter; and

FIG. 10 is a circuit diagram showing an embodiment of a lighting control circuit that switches on and off the LED holder.

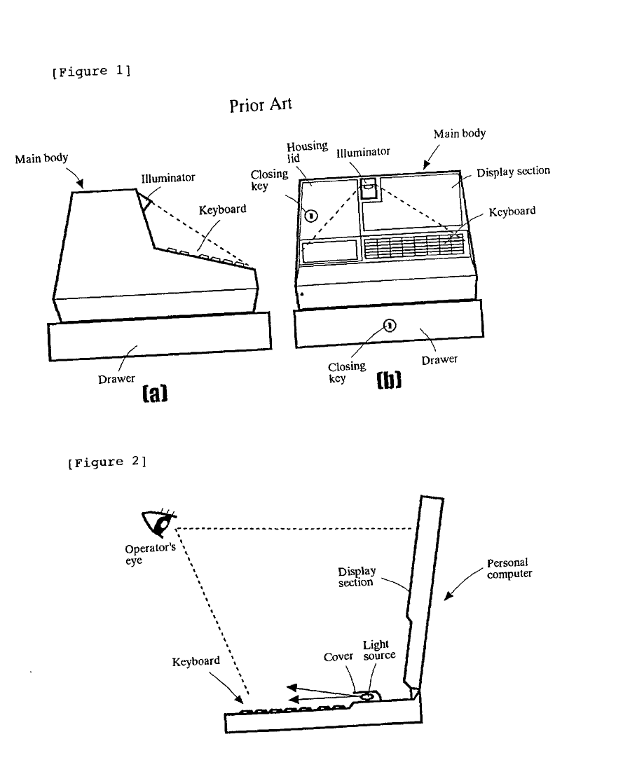

### DESCRIPTION OF SYMBOLS

101 . . . Main body

103 . . . Keyboard

105 . . . Back cover

109 . . . LCD

150 . . . LED holder

155 . . . LED

161 . . . Aperture

### DETAILED DESCRIPTION OF THE INVENTION

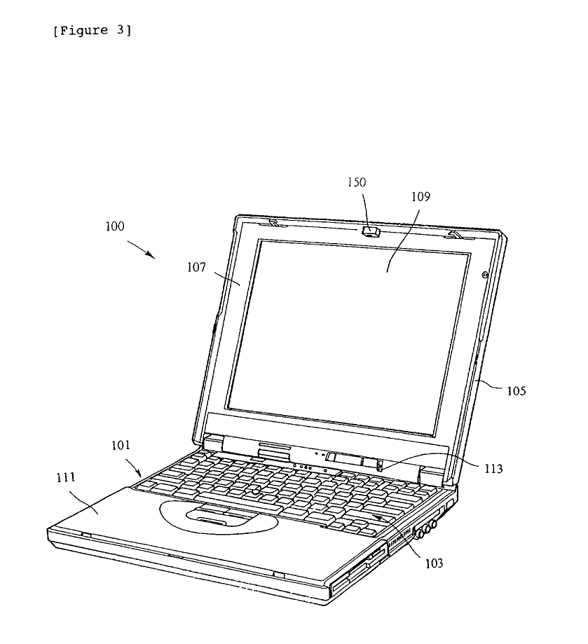

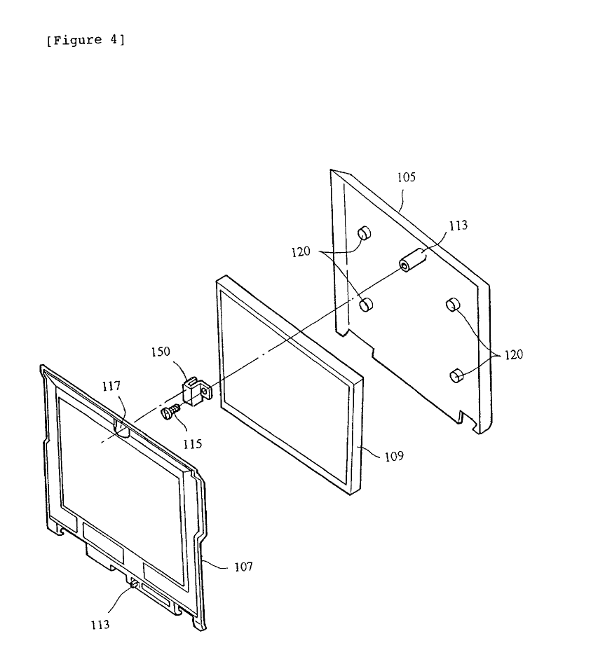

FIG. 3 shows an embodiment of a notebook-sized portable computer 100 to which the present invention is applied. A keyboard 103 is disposed on the upper surface of a main body 101, and a palm rest 111, for holding the palms of a user when the user operates the keyboard, is disposed on this side of the keyboard. A back cover 105 is attached at one end thereof to approximately an end of the main body 101 so that it can be opened and closed. The back cover 105 plays a role of covering the keyboard 103 and the palm rest 111 in its entirety when the computer is not used. A liquid crystal display (LCD) 109 is attached to the back cover 105 and a bezel 107 is also attached to the back cover 105 so that it covers the circumference of the LCD 109 and the circumference of the back cover. In using the computer 100, the user rotates the back cover 105 to 90 degrees or greater with respect to the main body 101 and operates the keyboard 103 while viewing the LCD.

The computer 100 is further provided with an LED holder 150, which holds an LED for keyboard illumination, and an LED switch 113 in the interior thereof. With the back cover 105 opened, the user operates the switch 103 to light the LED, whereby the keyboard 103 can be illuminated.

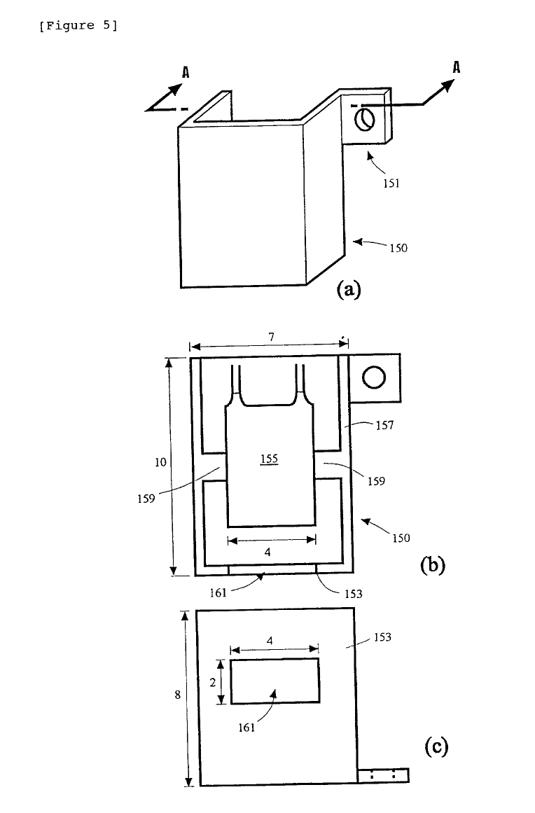

FIG. 4 illustrates the disassembled state of the back cover 105, the LCD 109, the bezel 107, and the LED holder 150. The back cover 105 is provided with a boss 113 threaded inside, and the LED holder 150 is passed through the aperture 117 of the bezel 107 and is attached to the boss 113 by means of a screw 115. The back cover 105 is formed with bosses 120 that attach the LCD 109 to the back cover 105. The bezel 107 is provided with the switch 113. FIG. 5 shows an enlarged view of the LED holder 150. In FIG. 5A the fixing portion 151 of the LED holder 150 is attached to the boss 113. FIG. 5B shows a sectional view taken along line A-A in FIG. 5A; FIG. 5C shows a bottom view of the boss 113 shown in FIG. 5B. An LED fixing portion 159 extends inward from a side wall 157, the central portion of the LED fixing portion 159 being provided with an aperture so that it can insert and fix the LED 155. The LED 155 is inserted to this aperture from the upper portion and fixed to the LED holder 150. In addition, as shown in FIG. 5C, the bottom portion 153 of the LED holder 150 is provided with an aperture 161. Part of the light emitted from the LED 155 is intercepted by the bottom portion 153, while the remaining part is emitted outside the LED holder 150 via the aperture 161.

This embodiment has adopted the LED as the light source. As the LED 155, NSPWF50BS manufactured by Nichia Chemical Industries, Ltd., for example, can be utilized. The LED 155 has luminous intensity 0.18 cd and power consumption 252 mW and thus has characteristics of luminous intensity and lower consumption power sufficient to illuminate the keyboard. In addition, the sectional size of the light emitting portion is as small as 2′4 mm and can be housed in the LED holder the size shown in FIG. 5. Because the battery capacity of the computer 100 is 4800 mAh, the rate of the power consumption of the LED to the battery capacity is about 1.6%. The LED 155 is able to operate for 3 hr under standard operating conditions with the LED 155 off, and even if the LED 155 is kept on under the same condition, the operating time of the computer 100 will be shortened only by about 3 min.

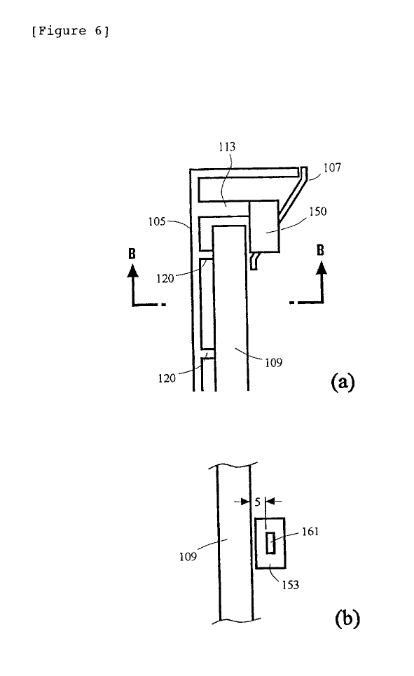

FIG. 6 shows the attached state of the LED holder 150 to the back cover 105. The LED holder 150 and the LCD 109 are attached to the back cover 105 by the boss 1 1 3 and the bosses 120, respectively. The bezel 107 covers the circumference of the LCD 109 and the end portion of the back cover 105, and at the portion to which the LED holder 150 is attached, the bezel 107 is provided with an aperture so that the bottom portion 153 of the LED holder appears outside the bezel.

In FIG. 6(B), the size of the aperture 161, the distance of the aperture 161 from the surface of the LCD 109, and the angle of the bottom portion 153 with respect to the surface of the LCD are important. The reason for this is that these parameters become major causes which determine the light distribution characteristic of the light radiated downward from the LED holder 150. In this embodiment, the size of the aperture 161 is 4 mm′2 mm, the distance from the LCD surface to the aperture 161 is 5 mm, and the angle of the bottom portion 153 with respect to the LCD surface is approximately 90 degrees. This light distribution prevents light radiated by the LED 155 from directly illuminating the LCD surface, whereby the visual recognition of the LCD is not disturbed. Furthermore, the light distribution characteristic is determined so that, during use of the computer, the entire keyboard is effectively illuminated in the range of a predetermined inclined angle of the back cover 105. The setting of the light distribution characteristic will be described in detail infra.

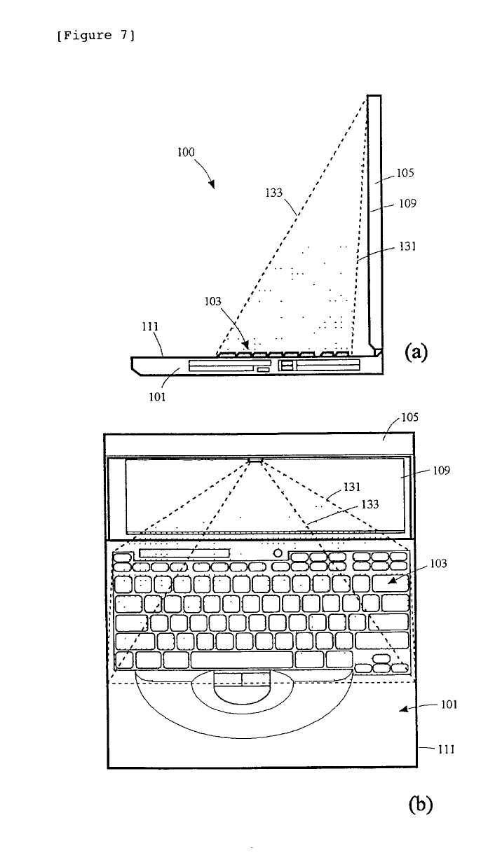

FIG. 7 shows, in the portable computer 100, the light distribution characteristic of the light emitted from the LED holder 150 housing the LED 155. FIG. 7A is a side view, the back cover 105 being opened so that it is held at approximately 90 degrees to the main body 101. In the inclined state of the LCD, a ray of light 131 nearest to the LCD 106 illuminates the end of the keyboard nearest to the LCD. The light ray 131 is determined by the angle of the bottom portion 153 of the LED holder 159 with respect to the LCD surface, the size of the aperture 161, and the distance of the aperture 161 from the LCD surface, as shown in FIG. 6B. In FIG. 7A, the light ray 131 has been illustrated so that it illuminates the portion of the keyboard 103 nearest to the LCD 109, but the illustration has been made of a light ray having illuminance suitable for keyboard illumination. Actually, a weak ray of light going from the aperture 161 toward the LCD 109 is also emitted.

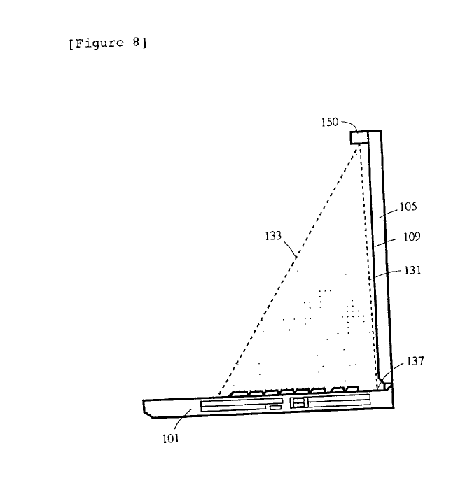

The distribution of this weak light ray will be described with FIG. 8. Part of the light emitted from the LED holder 150 includes a weak light ray going in the direction of the LCD 109, like the light ray 135. However, in this embodiment, the above-mentioned parameters, such as the size of the aperture 161 and the like, are determined so that the light ray 135 does not go to the LCD side beyond the coupled portion 137 between the back cover 105 and the main body 101. Therefore, even when the back cover is used at any angle, there is no possibility that the light will illuminate the LCD 109 directly and therefore there is no possibility that the visual recognition of the LCD will be disturbed.

Returning again to FIG. 7, the above-mentioned parameters, such as the size of the aperture 161 and the like, are determined so that, when the back cover 105 is open to 90 degrees, a ray of light 133 farthest from the LCD 109 illuminates the farthest end of the keyboard 103 from the LCD. FIG. 7B shows a plan view of the computer shown in FIG. 7A. As shown in FIG. 7B, the light distribution characteristic is determined so that, when the back cover is open to 90 degrees, the entire keyboard is illuminated. There is no possibility that the computer 100 will be used with the back cover 105 opened to less than 90 degrees. Generally, the computer 100 is used in a range of 110 to 135 degrees. Therefore, the computer 100 is often used with the back cover further opened from the position of FIG. 7A with respect to the main body 101. If the inclined angle of the back cover 105 is gradually increased, the light ray 133 will move to this side of the main body 101 and move beyond the main body 101. However, the entire keyboard 103 is still illuminated, so there is no obstacle in the operation of the keyboard under a dark environment. Since the movement quantity of the distal end of the light ray 131 is extremely small, there is also no obstacle in the illumination of the end of the keyboard 103 near the LCD.

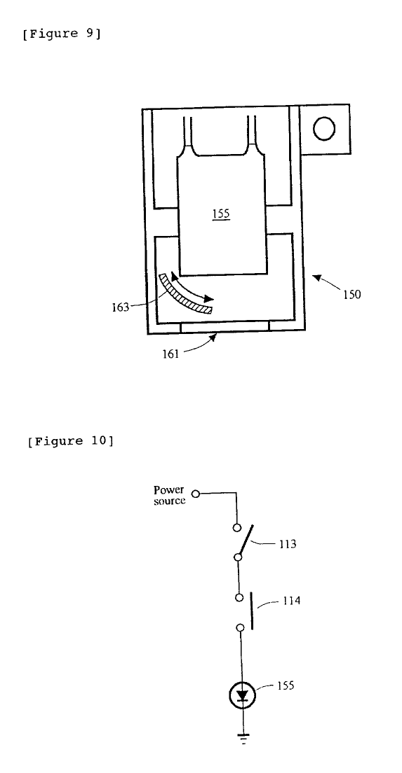

FIG. 9 illustrates a shutter 163 provided within the LED holder in order to prevent the light ray 133 from extending beyond the main body 101 and illuminating an unnecessary range when the back cover 105 is gradually inclined. The shutter 163 is provided within the LED holder 150 so that it is manually slidable. A mechanism for manually sliding the shutter 163 may be a mechanism which extends a shaft for fixing the shutter 163 outward from the side wall 157 of the LED holder 150 and attaches a control dial to the shaft, or may adopt any other known mechanism. It is preferable that the slid shutter 163 be provided with a locking mechanism that locks the shutter 163 at arbitrary positions. The shutter 163 fulfills a role of adjusting the opening degree of the aperture 161 in accordance with the inclined angle of the back cover 105.

The control of switching on and off the LED in accordance with this embodiment is performed by the switch 113 shown in FIG. 3. If the LED 155 is always on, when the switch 113 is on, there are cases where the back cover 105 is closed with the LED 155 on. To prevent this, a second switch 114 interlocking with the operation of opening and closing the back cover 105 is added to a lighting control circuit, as shown in FIG. 10. The LED 155, the switch 113, and the second switch are connected in series to a power source. The second switch 114 is on only when the back cover is open. In this state, the switch 113 is switched on or off, whereby the LED 155 can be switched on or off.

According to the present invention, a computer disposing an LED for keyboard illumination on the upper portion of a display not realized in the background art can be provided. This computer never degrades portability, is low in battery consumption even when the illuminator is lit, and is able to perform effective keyboard illumination having no obstacle to the visual recognition of the LCD.

1. A computer capable of battery powered operation, having a keyboard and a display comprising:
an LED holder installed at approximately an upper edge of the display LED, the holder having a wall including an aperture; and
an LED installed inside the wall of the LED holder,
wherein light radiated from the LED illuminates the keyboard by passing through the aperture.

2. The computer of claim 1, wherein the wall of the LED holder masks a part of the light radiated from the LED to avoid a direct illumination to the display by the light passing through the aperture.

3. The computer of claim 1, wherein the wall of the LED holder intercepts part of the light radiated from the LED so that, when the display is opened so that it is held at approximately 90 degrees to the keyboard, the light passed through the aperture illuminates substantially the keyboard alone.

4. The computer of claim 1, wherein the LED holder has a shutter that is manually operable so as to shut part of the aperture.

5. A portable computer capable of battery powered operation, having a main body with a keyboard on its upper surface, a back cover pivotably connected at a lower edge thereof to approximately a back edge of the main body, and a liquid crystal display installed in the back cover, the portable computer comprising:
an LED holder installed at approximately a center of approximately an upper edge of the back cover, the holder having a wall including an aperture; and
an LED installed inside the wall of the LED holder,
wherein light radiated from the LED illuminates the keyboard by passing through the aperture.

6. The portable computer of claim 5, further comprising a switch that switches off the LED when the back cover is closed.
